(19) United States
(12) Patent Application Publication
(10) Pub. No.: US 2013/0203397 A1
(43) Pub. Date: Aug. 8, 2013

(54) PHONE THAT PREVENTS ACCIDENTAL DIALING TO A CONTACT

(71) Applicants: JOEL VIDAL, New York, NY (US); Yael Vidal, New York, NY (US)

(72) Inventors: JOEL VIDAL, New York, NY (US); Yael Vidal, New York, NY (US)

(21) Appl. No.: 13/365,236

(22) Filed: Feb. 2, 2012

(51) Int. Cl. H04W 4/00

(52) U.S. Cl. 455/418

(57) ABSTRACT

The present invention includes a phone having a contact list. At least one contact on the contact list may be associated with an indication that outgoing phone calls, that are attempted to be placed from the phone towards that contact, are to be blocked by the phone. The blocking of the attempt to place an outgoing phone call to a contact may be overridden by the user of the phone, for example, by confirming in response to a confirmation question, or by correctly providing a password or a pre-defined response to a question. Optionally, the phone may automatically analyze call logs and other data in order to recommend to the user contacts that are suitable for being associated with outgoing call blocking; for example, a contact corresponding to a person or entity that the user have not called frequently or for a long time.

### FIELD

Some embodiments are related to the field of wireless communication.

### BACKGROUND

Many people use a cellular phone in order to make and receive phone calls. For example, a user may utilize a cellular phone in order to talk with friends, family members, and business associates while being away from the user's home or office.

Many users utilize a smartphone, which may include features of a cellular phone as well as features of a Personal Digital Assistant (PDA). For example, a smartphone may be used for placing and receiving phone calls, as well as for browsing the Internet, taking photographs by utilizing an integrated camera, playing games, sending and receiving electronic mail (email), or the like.

### SUMMARY

Some embodiments may include, for example, a phone that prevents accidental or unintentional placement of an outgoing phone call (or other type of outgoing communication) towards a contact that is part of a contact list associated with the phone.

Some embodiments may include, for example, a cellular phone or smartphone or other phone having a contact list. At least one contact on the contact list may be associated with a user-selected or user switchable indication or flag or “Call Lock”, indicating that outgoing phone calls attempted to be placed from the phone towards that contact, are to be blocked by the phone.

The blocking of an attempt to place an outgoing phone call to a contact may be overridden by the user of the phone, for example, by confirming in response to a confirmation question, or by correctly providing a password or a pre-defined response to a question.

Optionally, the phone may automatically analyze call logs and other data in order to recommend to the user contacts that are suitable for being associated with outgoing call blocking; for example, a contact whom the user did not call for a long period of time.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a phone, in accordance with some demonstrative embodiments.

FIG. 2 is a schematic illustration of a contact list displayed on a display unit of a phone, in accordance with some embodiments of the invention.

FIG. 3 is a schematic illustration of another contact list displayed on a display unit of a phone, in accordance with some embodiments of the invention.

### DETAILED DESCRIPTION OF SOME EMBODIMENTS

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

The term “phone” as used herein may include, for example, a cellular phone, a cellphone, a smartphone, a cordless phone (e.g., typically used in homes), a DECT phone, a mobile phone, a corded phone, a wireless communication device, or the like. Optionally, the term “phone” may include, for example, a tablet, a tablet computer, a tablet device, a handheld device, a portable device, an electronic device, a device able to send and/or receive phone calls, a device able to send and/or receive text messages and/or SMS messages and/or MMS messages and/or Instant Messages, or the like.

Some embodiments include, for example, a phone which allows the user to create and store contacts. A user may create, store, modify, edit and/or store contacts, which may include, for example, a first name, a last name, and a phone number; and optionally other fields of data (e.g., Email address, nickname, fax number, or the like). The user may utilize a User Interface (UI) or a Graphic UI (GUI) in order to view or browse the contact list, and in order to select a contact therefrom. For example, the use may tap with his finger on a touch-screen which displays the contact list (or portions thereof), thereby commanding the phone to place an outgoing phone call to that contact.

The inventors have realized that some users store, in their contact list, names and phone numbers of people that they are no longer interested in calling. This may include, for example, details of a previous (non-current) friend or acquaintance, a previous spouse, a person or entity that the user used to be in touch with but is generally no longer in touch with (e.g., a previous co-worker, a previous landlord, a previous tenant, a previous nanny, a previous cleaning person, a previous tutor, a previous dentist or attorney, or the like). The inventors have realized that a contact list of a user may include, for example, a contact called “Joe my ex-husband” followed by “Joey the Plumber”; and that a user may accidentally initiate an outgoing phone call to “Joe my ex-husband” due to tapping, by mistake, on the contact of “Joel my ex-husband” instead of tapping on “Joey the Plumber”. The inventors have realized that such a mistaken placement of an outgoing call, may cause damage, embarrassment, or other undesired consequences to the user who mistakenly placed the outgoing phone call. The inventors have realized that this phenomenon is not mitigated, but rather, is continuously aggravated, as users of phones (and particularly of smartphones) continue to add names to their ever-expanding contact list, while hardly ever making an effort to delete or remove contacts with whom they are no longer in touch.

In accordance with some embodiments of the present invention, a user of a phone is able to command his phone to add a “lock” or a “call lock” to a contact stored in the contact list, or to a set of user-selected contacts from such contact list. For example, the user may flick or toggle a displayed “switch” or button, which indicates to the phone that the user desires that this contact list becomes “locked”. Upon locking of such a contact, the phone blocks any outgoing phone call attempted to be placed towards that locked contact; and/or the phone blocks any outgoing communication (e.g., phone call, SMS message, MMS message, text message, Instant Message, Email, video call, audio call) attempted to be placed towards that contact. The blocking may be performed, for example, together with notifying the user that the outgoing communication (e.g., phone call) is blocked because that contact has been previously marked by the user as “locked”. The blocking may be maintained by the phone, for example, until or unless the user performs one or more pre-defined or user-defined steps or actions to remove the lock and/or to temporarily authorize the outgoing communication (even though the lock continues to exist). Such actions may include, for example, responding positively to an “are you sure?” question; answering a user-defined security question (e.g., “what is your mother's maiden name?”); answering a general knowledge question (e.g., “how much is 3 plus 4”, just in order to ensure that the user is fully aware of the outgoing communication and has not tapped the contact by mistake); entering a user-selected PIN or password; making a particular gesture (e.g., drawings a triangle with a finger on a touch-screen of the phone); or the like.

Some embodiments may prevent a user of a phone from accidentally dialing (or, accidentally initiating other type of communication) with a contact stored in the contact list; due to a previous locking or blocking of the contact by the user; either entirely, or until the lock is removed by the user, or until the blocking is traversed by performing one or more pre-defined actions.

Some embodiments may allow a user to keep on his phone contacts, that the user does not intend to call, while “locking” them; in order to keep their contact data available to the user, or for backup purposes; and/or in order to allow the phone to display the contact details (and particularly, the user-created contact name or contact nickname) if an incoming call is received from that contact. For example, the user may be able to keep the contact “Joe my ex-husband” on her phone, in order to allow the phone to display “Joe my ex-husband is calling” upon an incoming phone call from that contact; together with blocking the user from placing a call to that contact due to a user-placed lock on that contact.

In some embodiments, the phone may include a memory unit or storage unit, which may store contacts as records or fields or other suitable format of data items. For example, each contact may be stored as a record, having one field for first name, another field for family name, another field for phone number, another field for email address, or the like. An additional field or bit or flag may be used, in order to indicate whether or not that contact is locked from being called from that phone. Optionally, multiple fields or bits or flags may be used, to indicate, for example, whether that contact is locked from being called (a first flag), is locked from being texted a text message (a second flag), is locked from being a recipient of an email (a third flag), or the like. Optionally, further field(s) may be associated with each flag, indicating what additional steps are required in order to remove the lock (e.g., answer a security question, with the additional fields storing the security question and/or the correct answer to it; or the required PIN or password). Optionally, further field(s) may be associated with each flag, indicating what additional steps are required in order to temporarily overcome the lock and authorize the outgoing communication while ignoring the sustained lock (e.g., answer a security question, with the additional fields storing the security question and/or the correct answer to it; or the required PIN or password).

Optionally, each lock may be associated with a user-defined expiration date or expiration time; such that the lock expires automatically at a certain date and/or time, thereby allowing the user to block calls for a predefined time period. For example, a user may define in June that a contact associated with his accountant be locked until January 1 of the subsequent year, in order to block accidental call to the accountant prior to “tax season”. The phone may periodically (e.g., daily, hourly, or the like) scan the expiration dates of locks, and may automatically remove or expire locks whose expiration date or time has elapsed.

The following table, denoted Table 1, demonstrates data storage of a contact list in a phone, or associated with a phone, in accordance with some embodiments. Each contact or record comprises a set of fields, storing first name, last name, phone number, and a binary flag indicating whether or not a Call Lock is associated with that record or contact.

TABLE 1

| First Name | Last Name | Phone Number | Call Lock |
|---|---|---|---|
| Joe | Smith | 212-555-6789 | Y |
| Joey | Tran | 212-555-1234 | N |

The following table, denoted Table 2, demonstrates data storage of a contact list in a phone, or associated with a phone, in accordance with some embodiments. Each contact or record comprises a set of fields, storing first name, last name, phone number, and a binary flag indicating whether or not a Call Lock is associated with that record or contact; and further comprising a binary flag indicating whether or not an SMS lock is associated with that record or contact (e.g., to prevent or block accidental “texting”, or sending of an outgoing text message or SMS message, to that contact). For example, a user may indicate to the phone that a particular contact does not agree to receive, or is unable to receive, text messages and thus an SMS Lock or Text Lock may be placed by the user in order to prevent the user from mistakenly or forgetfully attempt to send a text message to that user (and then, incorrectly assume that the text message reached the recipient).

TABLE 2

| First Name | Last Name | Phone Number | Call Lock | SMS Lock |
|---|---|---|---|---|
| Joe | Smith | 212-555-6789 | Y | N |
| Joey | Tran | 212-555-1234 | N | Y |

The following table, denoted Table 3, demonstrates data storage of a contact list in a phone, or associated with a phone, in accordance with some embodiments. Each contact or record comprises a set of fields, storing first name, last name, phone number, and a binary flag indicating whether or not a Call Lock is associated with that record or contact; and further comprising a field indicating a security question and the correct response to it (or other challenge-response pair). The security question may be presented to the user once she attempts to place a call to the locked contact; if the user enters the correct response, then the call may be authorized and the Call Lock may be temporarily ignored on an ad-hoc basis (or, may be removed).

TABLE 3

| First | Last | Phone | Call | | Security |
|---|---|---|---|---|---|
| Name | Name | Number | Lock | Security Question | Answer |
| Joe | Smith | 212-555-6789 | Y | Your pets name? | Clifford |
| Joey | Tran | 212-555-1234 | N | Null | Null |

The following table, denoted Table 4, demonstrates data storage of a contact list in a phone, or associated with a phone, in accordance with some embodiments. Each contact or record comprises a set of fields, storing first name, last name, phone number, and a binary flag indicating whether or not a Call Lock is associated with that record or contact; and further comprising a field indicating an expiration date and/or time, in which the Call Lock (or other suitable type of lock defined by the user) shall automatically expire. A Call Lock that does not has expiration time/date set, may be stored, optionally, as a Call Lock having an expiration date set 99 years into the future, or other remote date.

TABLE 4

| First | Last | Phone | Call | Call Lock | Expiration Date |
|---|---|---|---|---|---|
| Name | Name | Number | Lock | Expires? | (and Time) |
| Joe | Smith | 212-555-6789 | Y | Y | 2012-08-27 |
| Joey | Tran | 212-555-1234 | N | Null | Null |
| Ken | Wade | 212-555-4343 | Y | N | Null |

In some embodiments, the phone may allow the user to override a blocking of an outgoing phone call, which a user attempts to place towards a contact associated with a Call Lock, prior to the user selecting that contact or attempting to place the phone call to that contact. For example, prior to viewing the contact list, and/or prior to selecting a contact to be called from the contact list, the user may command the phone, by selecting a predefined command, to temporarily override on an ad hoc basis the blocking of the next outgoing phone call, regardless of the contact identity and regardless of whether or not the selected contact is protected under a Call Lock. For example, a user may be in a rush to place a call to the contact “Joe the Plumber”; the user may not recall whether or not that contact is currently associated with a Call Lock; the user may select on the phone a command of “override the blocking of my next dial-out attempt”; and only then, open the contact list and select from it the contact of “Joe the Plumber”. Even if that contact is associated with a Call Lock, the phone may ignore or override the Call Lock on a one-time ad hoc basis, and may authorize the outgoing phone call placed towards that contact.

Some embodiments may be utilized in conjunction with, for example, a locally-stored contact or contact list; a remotely-stored contact or contact list; a contact or contact list stored on a SIM card, or on SD card, or in phone memory; a contact or contact list stored in a remote “cloud” or in a “cloud computing” storage system; a contact or contact list stored in a remote email server or web-mail server; or any combination of the above.

Some embodiments may be used in conjunction with speech-recognition components and/or voice-activated components, or with an interface in which the user provides voice commands to the phone by talking to the phone. For example, the user may place a Call Lock on a current contact by commanding, in his voice, “open contacts”, then commanding by voice “find Joe Smith”, then commanding by voice “Lock this contact”. Subsequently, the user may attempt to call that contact, by commanding the phone via voice to “Call Joe Smith”; and in response, the phone may notify the user, via text or via speech, that this contact is locked. Optionally, the phone may present to the user a challenge-response process, or a question or set of questions, which the user may respond to by voice and/or by other means. For example, the phone may display, or may say to the user, “This contact is locked from being called; are you really sure that you want to override the Call Lock and place the call to Joe Smith?”, and the user may respond by saying “yes” (or “no”) or by tapping on a button that indicates “yes” (or “no”).

Optionally, the phone may present to the user a relatively easy obstacle or question or challenge, which a typical user may relatively easily traverse, but which cannot be traversed with a simple “yes” response (for example, since some users may be prone to clicking “yes” in various computerized dialogues without putting minimal thought into the situation presented to them). For example, the phone may present to the user a simple or easy mathematical question, such as, an easy addition question (“How much is 3 plus 4”), an easy subtraction question (e.g., “how much is 8 minus 2”), a simple multiplication or division question, a simple general-knowledge question (e.g., “What is the capital of France”, with the pre-defined correct answer being “Paris”), or the like.

In some embodiments, creation of a Call Lock for a particular contact, may operate in, or may have cross-effects in, other applications or features of the phone. For example, “Joe the Plumber” may be a contact in the contact list; and may also be a Direct Dial shortcut having a one-click or speed-dial icon on the desktop of the display unit of the phone. The user may edit the contact of “Joe the Plumber” to place a Call Lock thereon. As a result, the phone may automatically associated that Call Lock, with both of: outgoing phone calls that are attempted by the user via selecting of the contact “Joe the Plumber” on the contact list; and/or, outgoing phone calls that are attempted by the user via selecting the Direct Dial shortcut “Joe the Plumber” through the corresponding speed-dial icon on the desktop or user interface displayed by the phone or used by the phone.

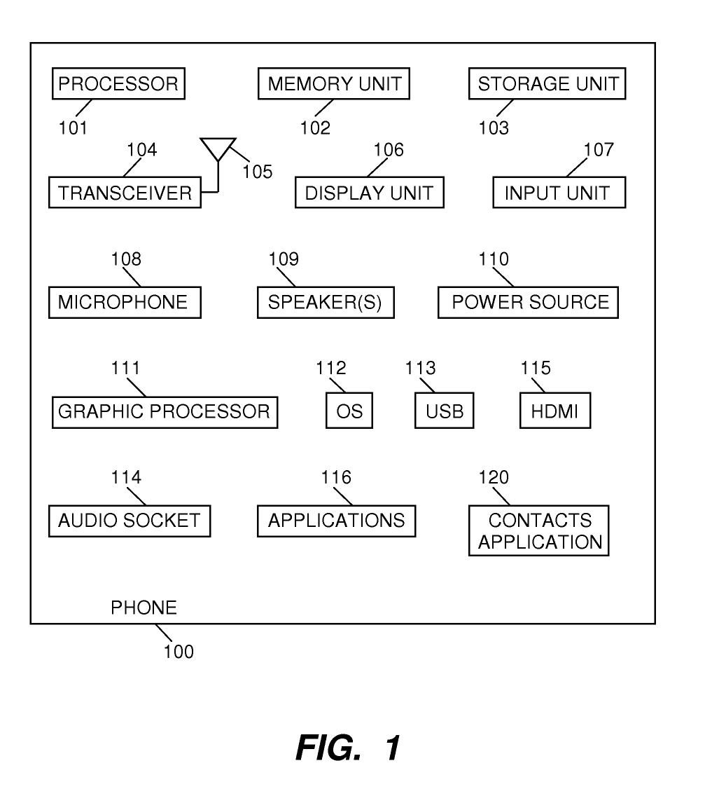

Reference is made to FIG. 1, which is a schematic block diagram illustration of a phone 100, in accordance with some demonstrative embodiments. Phone 100 may include, for example, some or all of the following components: a processor 101 (e.g., a general purpose processor, a specific processor, a controller, a Central Processing Unit (CPU), circuitry, an Integrated Circuit (IC), a logic component, a single-core or multiple-core processor, or the like); a memory unit 102 (e.g., phone memory; Secure Digital (SD) card; SIM card; Flash memory; volatile memory; non-volatile memory; RAM; or the like); a storage unit 103 (e.g., a Flash storage unit, a miniature hard disk, a SIM card, non-volatile storage); a wireless transceiver 104 (e.g., wireless transmitter and/or wireless receiver, a cellular transceiver, a 2G transceiver, a 3G transceiver, a 4G transceiver, a 4G LTE transceiver, a Wi-Fi transceiver, a Wi-Max transceiver, a 3GPP transceiver, an IEEE 802.11 transceiver, an IEEE 802.16 transceiver, or the like); an antenna 105 (e.g., an internal antenna, an external antenna, an internal/external antenna, an omni-directional antenna, a monopole antenna, a dipole antenna, an end fed antenna, a circularly polarized antenna, a micro-strip antenna, a diversity antenna, or the like); a display unit 106, (e.g., a screen, a touch-screen, a multi-touch screen, a screen able to present text and/or graphics and/or images and/or photographs); an input unit 107, (e.g., a physical keyboard, a physical keypad, an on-screen keyboard, an on-screen keypad, a mini joystick, a touch-pad, a touch-screen, a multi-touch screen, a tactile interface, or the like); a microphone 108 able to receive and/or sense and/or capture audio signals spoken or uttered by a user of phone 100; one or more speaker(s) 109 able to produce audio and/or sound; a power source 110 (e.g., a battery, a rechargeable battery, a replaceable battery, or the like); a graphic processor 111, (e.g., a Graphic Processing Unit (GPU), a graphics accelerator, or the like); an Operating System (OS) 112 (e.g., Apple iOS, Android, a Microsoft OS or a Windows OS, Symbian, a Linux or Unix OS, a Blackberry OS, or the like); a USB port 113 (or mini-USB port or micro-USB port); an audio socket 114 for connecting earphones or headphones and/or for providing audio output therethrough; an HDMI port 115 (or, mini-HDMI port or micro-HDMI port); one or more applications 116; and/or other suitable components (e.g., a front-side camera, a back-side camera, one or more physical buttons, or the like). Components of phone 100 may be enclosed in, or may be held in, a housing or enclosure.

Phone 100 may include a “contacts” application 120, which may be implemented as a software component and/or a firmware component and/or a hardware component, or may be integrated within phone 100 (e.g., implemented using ROM or an Integrated Circuit or circuitry). Optionally, the contacts application 120 may be provided by the manufacturer or vendor of phone 100; or may be a third-party application that a user of phone 100 may download and/or purchase and/or install (e.g., through an Applications Store or an Applications Market).

The user of phone 100 may utilize the contacts application 120 in order to create new contacts, delete existing contacts, modify contacts, view details of a contact, and take actions with regard to a contact (e.g., place a phone call outgoing to a contact; send a text message or SMS message or MMS message to a contact; send email to a contact).

A contact may include a set of fields or records, for example, a first name (e.g., “John”), a last name (e.g., “Smith”), a phone number (e.g., “212-555-6789”), an email address (e.g., “JohnSmith@Yahoo.com”), or the like.

In some embodiments, phone 100 may display to the user data regarding an incoming phone call. For example, phone 100 may recognize that an incoming phone call is being received from an originating phone number of “212-555-6789”; phone 100 may search through the contacts stored in phone 100, in order to check whether or not there is a contact stored already which includes this phone number. Phone 100 may determine, while the incoming phone call is ringing or is incoming, that the number from which the phone call originates (number “212-555-6789”) appears in the locally-stored contacts and is associated with the name “John Smith”; and thus, phone 100 may display to its user the originating phone number (“212-555-6789”) together with the name associated therewith (“John Smith”) as obtained from the locally-stored contact list. This may allow the user of phone 100 to know in advance, prior to answering the incoming phone call, the exact identity of the caller, identified by both the phone number and by the locally-stored contact name.

It is noted that the locally-stored contact name may be different from the name of the caller which appears in an official phone book. For example, the phone number “212-555-6789” may belong to John Smith, yet the locally-stored contact list may show a different user-selected name for that phone number, such as, “John the Plumber”, or “Johnny Boy”, or “John the Lawyer”, or “John from Citibank”, or “John S from College”, or the like.

When the user of phone 100 creates a new contact, or modifies or edits an existing contact, phone 100 may allow the user to put a Call Lock on that contact. A Call Lock means that the contact may appear in the list of contacts among other contacts; and may be viewed and searched; and the contact details may be viewed in detail; however, due to the Call Lock, the user may not place an outgoing phone call to that contact, at all, or easily.

In some embodiments, a contact associated with a Call Lock may not be called at all, until the user actively removes the Call Lock from that contact. The removal may require the user to perform one or more steps, to answer one or more confirmation questions (e.g., “are you sure you want to remove this Call Lock?”), to enter a previously-defined user-selected PIN or password, or the like).

In some embodiments, a contact associated with a Call Lock may not be called directly or easily, or may not be called unless the user performs one or more steps, or unless the user answers one or more confirmation questions (e.g., “are you sure you want to call this contact?”), or unless the user enters a previously-defined user-selected PIN or password, or the like.

In some embodiments, in order to place an outgoing call to a contact associated with a Call Lock, the user of phone 100 may be required to make one or more gestures with his hand(s) or finger(s); to perform certain gesture(s) on a touch-screen or multi-touch screen of phone 100; to flick a switch displayed on a touch-screen of phone 100; to answer “yes” to one or more questions or warnings displayed to the user on phone 100; to answer a riddle or a question or one or more security questions presented to the user by phone 100 (e.g., “what is your mother's maiden name?”), and/or traverse other obstacles presented to the user by phone 100. Such obstacles may be user-selectable or user-definable in advance, such that the user may define in advance which actions are to be performed, or which obstacles are to be traversed, in order to allow placement of an outgoing phone call to a contact associated with a Call Lock.

In some embodiments, contacts application 120 may store multiple records corresponding to multiple contacts. Each such record (namely, each contact) may include a field or flag which indicates, whether or not that contact is associated with a Call Lock. Optionally, data may be stored by contacts application 120, indicating the steps required for removing a Call Lock from a contact, or indicating the steps required for traversing one or more obstacles or questions or security questions in order to authorize the placement of the outgoing phone call.

In some embodiments, placement of an outgoing phone call to a contact associated with a Call Lock may be impossible or may be more difficult or may be less user-friendly or may be more cumbersome or more time-consuming or more effort-consuming, relative to placement of an outgoing phone call to a contact that is not associated with a Call Lock.

Some embodiments may allow a user to continue storing in his contact list various contacts, that he would like to keep for information purposes but that he does not intend to intentionally call (at all, or frequently), without the concern that such contact be accidentally called (e.g., due to “pocket dialing” performed accidentally; due to tapping on the wrong contact in a list, e.g., tapping on “John Ex-Boyfriend” instead of tapping on “Joe the Plumber”).

Furthermore, some embodiments may allow the user to keep, in his contact list, contacts that the users does not intend to call, in order to allow the phone 100 to display the contact name when an incoming call is received from such contact. For example, the user may add a contact of “Joe my Ex-Boyfriend”, associated with the phone number “212-555-1234”, and associated with a Call Lock. The user may not be able to call (at all, or easily) to that phone number, by tapping on the contact name or by choosing (intentionally or accidentally) that contact name from the contact list. However, if an incoming call is received from phone number “212-555-1234”, then phone 100 may display to the user that the incoming call is from “Joe my Ex-Boyfriend”, thereby providing to the user important information prior to her decision whether or not to answer the incoming phone call.

Although portions of the discussion herein may relate, for demonstrative purposes, to a Call Lock that prevents easy placement or accidental placement or unintentional placement of outgoing phone calls to a protected contact, some embodiments may similarly operate in order to prevent (at all, or easily, or efficiently) performing of other action(s) with regard to such protected contact. For example, optionally, if a contact is associated with a Call Lock, then the user may not be able (at all, or easily) to send a text message or Instant Message (IM) or SMS message or MMS message to such contact, or to place a video call outgoing to that contact, or to add such contact to a conference-call, or the like.

In some embodiments, the phone may automatically and/or autonomously deduce that a particular contact (or, a set of contacts, or a subset of the contact list), that is stored in the contact list, may be or should be a suitable candidate in order to be marked with a Call Lock; and, the phone may automatically and/or autonomously place such Call Lock on that particular contact, or, the phone may actively recommend to the user and/or notify the user that the particular contact (or, the set of contacts, or the subset of the contact list) be associated with a Call Lock; optionally, the phone may proceed to such Call Lock on such contact(s), upon or without a user confirmation after such notification or notification.

For example, the phone may automatically and/or autonomously determine that a particular contact is suitable to become, or should become, associated with a Call Lock because an automated analysis of the call log(s) or call history of the phone (which may include outgoing calls, answered calls, missed calls, or the like) indicates that this particular contact has not been called for a long period of time, or for a time period greater than a pre-defined threshold. For example, the phone may determine that a particular contact, which has not been called from the phone for at least four weeks, or at least 90 days, or at least five months, is a suitable candidate to be associated with a call lock. Upon such determination by the phone, the phone may suggest to the user to add a Call Lock to that particular contact, and the phone may proceed to place the Call Lock upon user confirmation; or, the phone may automatically place the Call Lock without requesting user confirmation and/or without notifying the user; and/or, regardless of whether a Call Lock has been placed (by the user, or by the phone automatically), the phone may ad hoc block an attempt of the user to place an outgoing call to that particular contact, and may warn the user with a notification such as, for example, “You have not called this contact, Joe the Plumber, for over 90 days now; are you sure you intended to call him?”, and the phone may present to the user a yes/no or confirm/decline user interface to confirm or decline the placement of the outgoing call.

In some embodiments, the user may pre-determine or may modify the time period, that should elapse since the last phone call placed towards a contact, so that the phone shall automatically associate such contact with a Call Lock, or such that the phone shall ad hoc block a placement of an outgoing call to that contact unless the user actively confirms or re-confirms. For example, the user may command the phone to automatically associate a Call Lock for any contact that appears in the contact list and was not called from the phone for at least K days, or for at least K weeks, or for at least K months or K years; where K may be a positive number. Alternatively, the user may utilize other means to convey a period of time to be used by the phone for automatic blocking of outgoing calls, such as, block a call outgoing to any contact that was not called for at least two months and one week, or, block a call outgoing to any contact that was not called since a particular calendar date (e.g., since Jan. 1, 2011).

In some embodiments, the phone may take into account other and/or additional data in order to determine the recommendation to place a Call Lock on a particular contact. For example, the phone may determine that a suitable candidate for (automatic, or user-confirmed) placement of a Call Lock, may be: a contact that has not been called out from the phone for at least N consecutive outgoing phone calls (e.g., at least 300 most-recent outgoing calls has been placed from the phone, without the particular contact being one of them; N may be a positive integer); and/or, a contact that has been called less than K percent of the total number of outgoing phone calls (in general, or this year, or in a particular time period such as in the past 12 months); and/or a contact from which the phone has received at least N incoming calls (in general, or in a particular time frame) that were missed, or were all declined to be answered by the user, or that at least N percent of them were missed or were declined and not answered by the user and; and/or a contact from which at least K text messages or SMS messages or email messages have been received (in general, or within a particular time frame), but no outgoing text messages or SMS messages or email messages (or, a small number or small percentage thereof) have been placed from the phone towards that contact.

For example, the phone may determine that, because the user declined to answer four incoming phone calls from “Joe the Plumber” in the last seven days, then that contact should be associated with a Call Lock, automatically and autonomously by the phone or subject to user confirmation. The phone may determine that because the user received eight incoming text messages from “Joe the Plumber” in the past three days, but did not place any outgoing text message(s) to that contact in the past three days and/or in response to the incoming text messages, that the user is probably not interested in communicating with that contact, not only by text messages but also by phone call; and thus, the phone may place a Call Lock, automatically or subject to user confirmation, on that contact. The phone may take into account call logs, text messages logs, email logs, SMS logs, MMS logs, video conference call logs, IM logs, and/or other suitable logs.

In some embodiments, a “prevailing” criterion may be used by the phone in order to determine that a particular contact, which would otherwise be a good candidate for automatic or semi-automatic placement of a Call Lock, should not actually be considered as such candidate. For example, if the user did not place an outgoing call to a particular contact for 8 months, and has not received any incoming call from that particular contact for 8 months, then the phone may determine that this particular contact is a suitable candidate for placement of a Call Lock; however, if the user edited the details of the contact two days ago, or, if the user sent an outgoing text message from the phone to that particular contact four days ago, then this may prevail and may indicate that this candidate is actually not a suitable candidate for automatic placement of a Call Lock.

In some embodiments, the phone may utilize contextual analysis of contact details, contact names, SMS messages, text messages, MMS messages, email messages, IM messages, and/or other data, in order to reach a determination whether a particular contact may or may not be a suitable candidate for automatic placement of a Call Lock (autonomously by the phone, or subject to receiving user confirmation to placement of the Call Lock). For example, creation of a contact name that includes the string “ex-boyfriend” or “ex-girlfriend” may indicate a suitable candidate for automatic placement of a Call Lock. For example, editing or modification of an existing contact, from “boyfriend” to “ex-boyfriend” may indicate a suitable candidate for automatic placement of a Call Lock (e.g., immediately, and without necessarily waiting for a time period to elapse in which the call log is monitored). For example, creation of a contact, or modification of a contact, to become or to include “fiancé” or “husband” or “wife” or “best friend” or “BFF” may indicate that this contact is not a suitable candidate for placement of a Call Lock. For example, the phone may monitor the content and/or context of messages that are received, sent and/or composed; and may determine via contextual analysis that if the user sent out to “John Smith” a text message of “I hate you, I don't want to speak with you ever again!”, or sent out to him an email message of “Stop harassing me, don't write me again!”, then that contact may be a good candidate for automatic placement of a Call Lock in order to block an attempt to place a phone call to that contact (and/or, optionally, to block an outgoing text message, email message, or other type of communication from the phone to that contact). A contextual analysis, or other type of analysis, may be used by the phone in order to deduce, from sent messages and/or received messages and/or drafted messages and/or composed messages, that the user of the phone has lost interest in communicating with a particular contact, and thus an automatic or recommended placement of a Call Lock on that contact is warranted.

In some embodiments, a user may pre-approve to the phone any and all types of suggested Call Locks; and the user may indicate that any time that the phone determines that a particular contact is a good candidate for a Call Lock, the phone should proceed to automatically create the Call Lock. In some embodiments, automatically-created Call Locks may be of a particular type, or of a user-defined type; such as, for example, of a type that requires the user to confirm or re-confirm the outgoing phone call (by presenting a confirmation question such as “Are you sure really sure that you intended to call Joe My Ex-Boyfriend?” and a yes/no user interface), or of other suitable type (e.g., requiring correct entering of a particular or general password).

In some embodiments, the contextual analysis may include, optionally, automatic monitoring by the phone of speech or dialogs uttered by the user and/or by another party during actual phone calls; and may include real-time analysis or off-line analysis of stored audio conversations; in order to determine candidacy for placement of Call Locks. For example, if a user said or uttered, in the last five seconds of a phone call with the contact “Jane Smith”, a phrase such as “I hate you!” or “I don't want to talk to you ever again!” or “Please do not call me again”, then this contact may be determined by the phone to be a good candidate for automatic or semi-automatic placement of a Call Lock. The phone may utilize, for this purpose, a speech-to-text converter module, a speech recognition module, or other type of converter and/or analyzer, in order to deduce this determination.

In some embodiments, contacts application 120 may include, or may be associated with, or phone 100 may include, one or more of the following modules and/or components: an “add contact” module or component to allow adding or creation of a new contact; an “edit contact” module or component to allow editing or modification of an existing contact; a “delete contact” module or component to allow deletion of an existing contact; a “Call Lock switch” module or component to allow creation of a new Call Lock on a contact, and/or removal of an existing Call Lock from a contact, and/or toggling or switching of Call Lock from one status to another status (e.g., enabled and disabled; activated and deactivated; operational and non-operational); a “view contact” module or component to allow viewing of contact details and contact properties; a “call contact” component or module to allow efficient placement and/or easy placement and/or one-click placement and/or dual-click placement of an outgoing phone call to a contact; a “log analysis” module or component able to analyze call logs and/or other communication logs in order to determine that one or more particular contacts are suitable candidates for automatic and/or semi-automatic association thereof with a Call Lock; a “contextual analysis” module or component able to analyze content, context and/or metadata of communication messages in order to determine that one or more particular contacts are suitable candidates for automatic and/or semi-automatic association thereof with a Call Lock; a “notification” module or component, which may be responsible for, for example, notifying the user that an attempted outgoing phone call is blocked, and/or, receiving user confirmation or re-confirmation or double-confirmation prior to overriding the blocking of the outgoing phone call, and/or, notifying the user that a particular contact (or a set of contacts) has been automatically associated by the phone with Call Lock(s), and/or, notifying the user that a particular contact (or a set of contacts) has been automatically determined by the phone as suitable candidate(s) to be associated with Call Lock(s) subject to user confirmation; a “Call Lock inserter” module or component able to associate a contact with a Call Lock; a “Call Lock remover” module or component able to deactivate or remove a Call Lock; a “Call Lock override” module or component able to authorize ad hoc overriding of an existing Call Lock, e.g., based on user confirmation or a correct user input in a challenge/response; an “outgoing call blocker” module or component able to block a user-initiated attempt to place an outgoing phone call towards a contact associated with a Call Lock; a “Call Lock recommender” or predictor module able to automatically and/or autonomously deduce that a certain contact in the contact list is a suitable candidate for automatic placement (without specific user confirmation) and/or semi-automatic placement (subject to specific user confirmation) of a Call Lock on such contact; and/or other suitable components or modules, which may be implemented by using hardware, software, UI components, or any combination thereof.

In some embodiments, “blocking” of an attempt to place an outgoing phone call to a particular contact, may be implemented by one or more suitable ways, for example: ignoring a user command to place the outgoing phone call; non-performance of the user command to place the outgoing phone call; greying-out or graying-out or crossing-out or removal or deletion or hiding of a button or User Interface component which is typically used for initiating an outgoing phone call to a contact (e.g., a phone icon); commanding the wireless transceiver of the phone to avoid placement of the outgoing call; avoiding or cutting the transfer of commands and/or data to the wireless transceiver of the phone (wherein the commands and/or data that were prevented would typically indicate a user instruction to place an outgoing phone call); disconnecting or cutting an already-placed phone call that the phone or its wireless transceiver have already commenced the process of dialing out to; and/or other suitable blocking operations, ignoring operations, elimination operations, circumvention operations, deactivation operations, disabling operations, or the like.

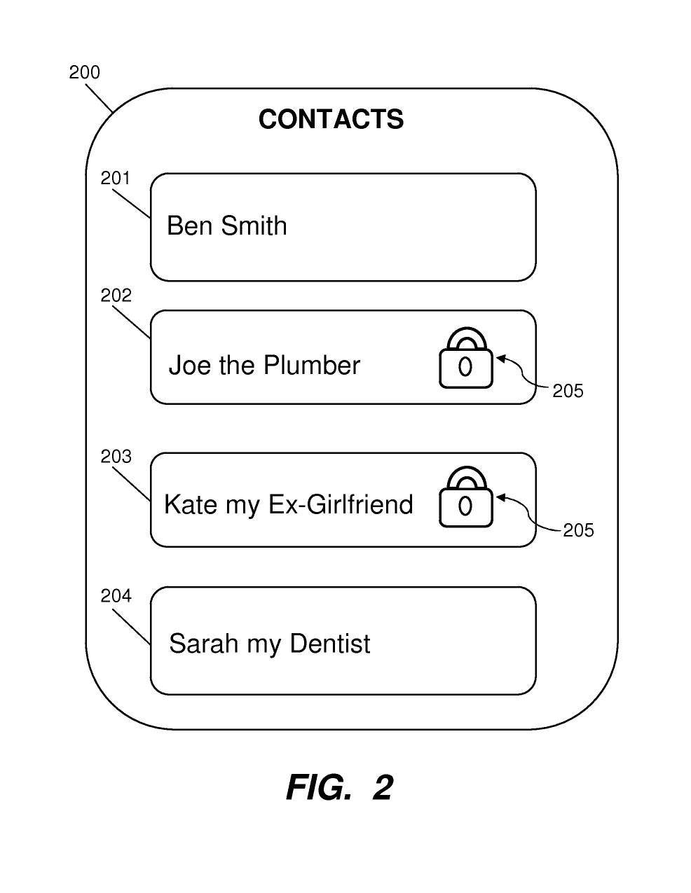

Reference is made to FIG. 2, which is a schematic illustration of a contact list 200 displayed on a display unit of a phone, in accordance with some embodiments of the invention. Contact list 200 may include, for example, four contacts 201-204. In a demonstrative example, contacts 202 and 203 may be associated with a Call Lock, and their displayed representation may optionally include a visual indication 205 (e.g., an image or icon of a lock; or of a phone with a diagonal line crossing thereon) that an outgoing phone call to these contacts is blocked. Contacts 201 and 204 may not be associated with a Call Lock, and thus, these contacts 201 and 204 may not show such visual indication of blocking of outgoing phone call to those contacts 201 and 204.

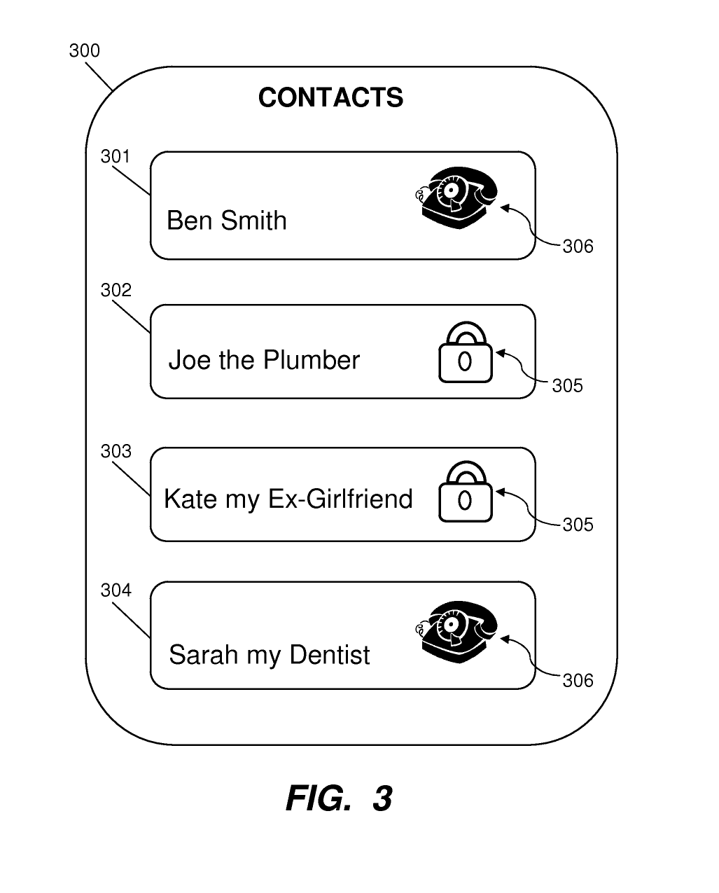

Reference is made to FIG. 3, which is a schematic illustration of a contact list 300 displayed on a display unit of a phone, in accordance with some embodiments of the invention. Contact list 300 may include, for example, four contacts 301-304. In a demonstrative example, contacts 302 and 303 may be associated with a Call Lock, and their displayed representation may optionally include a visual indication 305 that an outgoing phone call to these contacts is blocked. Contacts 301 and 304 may not be associated with a Call Lock; and instead of showing visual indication 305 of a Call Lock, contacts 301 and 304 may show a (different) visual indication 306 that a phone call may be placed towards those contacts 301 and 304 (e.g., an image or icon of a phone, optionally in green color).

In some embodiments, color codes and/or font effects may be used in order to distinguish between contacts that are not associated with Call Locks (which may be, for example, shown in green; and/or shown in bold font type; and/or shown in slightly enlarged font size), and contacts that are associated with Call Locks (which may be, for example, shown in red; and/or shown in slightly increased font size; and/or shown in grayed-out font or gray color).

In some embodiments, the user may command the contacts application to view all contacts that have a Call Lock; or, to view all contacts that do not have a Call Lock; or, to view all contacts; or, to search for a contact only through the contacts that have a Call Lock; or, to search for a contact only through the contacts that do not have a Call Lock; to use existence or absence of a Call Lock as a filter criterion, search criterion, display criterion, filter or filtering criterion; to export or to convert to another format only contacts that have (or, only contacts that do not have) a Call Lock; to remove all Call Lock; to show all the contacts having a Call Lock placed in a certain time frame (e.g., today, this week, this month, this year, in the past two weeks); and/or to perform other contact management operations which may take into account the existence or absence of Call Lock(s) as a parameter, filter or criterion.

In some embodiments, the contacts management application on the phone may be adapted, for example, to display to the user all contacts; to display to the user only contacts that are associated with a Call Lock; to display to the user only contacts that are not associated with a Call Lock; to allow the user to search the contact list for a particular contact while indicating to the contact application whether or not the searched contact is associated with a Call Lock; to allow the user to remove, in bulk, all Call Locks that may be associated with one or more of the contacts on the contact list; to allow the user to add, in bulk, a Call Lock to a subset of contacts (e.g., all contacts that include the word “landlord”, or all contacts that include the string “ex”); and/or to allow the user to otherwise manage the adding, the removal, or the toggling or switching of Call Lock(s) from one contact or from a group of contacts or from all the contacts.

In some embodiments, the user need not associate any contact with a particular “group” of contacts, and need not create “groups” of contacts (e.g., contacts from work, contacts who are friends, contacts who are family members), in order to selectively authorize or disallow placement of phone calls to user-selected contacts. In some embodiments, all the contacts may be defined as general contacts, and may not belong to any “group” or “type” of contacts, and may still be selectively chosen by the user in order to be associated with a Call Lock.

Some embodiments may include, for example, a cellular phone comprising: a wireless transmitter able to transmit wireless communication signals; a wireless receiver able to receive wireless communication signals; a processor able to execute code; a memory unit able to store a contact list; a display unit able to present said contact list in a scrollable format; an interface able to receive user input indicating a selected contact that a user wishes to call through said cellular phone. In response to the user input, if the processor determines that said particular contact is associated with an indication that said particular contact is protected from being called, then, the processor is to block an attempt of said user to call said particular contact.

In some embodiments, a cellular phone may include: a wireless transmitter able to transmit wireless communication signals; a wireless receiver able to receive wireless communication signals; a processor able to execute code; a memory unit able to store a contact list. The contact list may include: a first contact, comprising a first name associated with a first phone number; and a second contact comprising a second name associated with a second phone number. The contact list may include an indication that, based on a prior user request, said first contact is un-callable from said cellular phone (entirely, or unless the user of the phone performs one or more operations or answers one or more security questions or enters a previously-defined PIN or password). For each contact which is marked as un-callable, the processor is (A) to block an attempt to call said contact, and (B) to authorize a call incoming from said contact.

In some embodiments, a cellular phone may include a display, an input unit, a processor, a memory, and a contact list of names and phone numbers. In response to a user's command to display the contact list, substantially all the names of all the entities of the contact list are displayed. In response to a user selection of a particular contact from the displayed list, the user is able to toggle or to switch between or among at least two of the following modes: (a) making the particular contact directly callable from the cellular phone without requiring a confirmation or a password; (b) making the particular contact un-callable from the cellular phone unless the user first enters a password which matches a pre-stored password which protects said particular contact from being called from said cellular phone; (c) making the particular contact un-callable from the cellular phone unless the user first confirms (e.g., by pressing Y for “yes”; by selecting a “confirm” button or option; by entering a requested confirmation string).

In some embodiments, a cellular phone may include a program, implemented by software and/or hardware, to protect a particular phone number and/or a particular name on a locally-stored contact list, from being called from the cellular phone upon user selection of said phone number or name; the protection being, one or more of: requiring the user to confirm by entering Yes or Y or a particular string, or a password which has to match a pre-stored user-defined or user-modifiable password.

In some embodiments, each contact or phone number may be associated with its own unique calling-confirmation password. In other embodiments, all, or some, or a group of phone numbers or contacts, may be associated with one (or more) common calling-confirmation password(s) or “release procedure” to unprotect the contact(s) and/or to allow placement of an outgoing phone call to such contact(s).

In some embodiments, the cellular phone may include: a processor able to execute code; and an interface to receive a user command to call the first phone number. In response to said user command, the processor is (a) to block an attempted phone call to the first phone number, and (b) to generate a notification to the user that the attempted phone call to the first phone number is blocked.

In some embodiments, the cellular phone may include: a wireless receiver able to receive wireless communication signals; and a display unit able to display information. The wireless receiver is able to receive a phone call incoming from said first contact. In response to the phone call incoming from said first contact, and prior to said phone call being answered by a user, the processor is to cause the display unit to display said first phone number and said first name which identify said first contact;

In some embodiments, the contact list comprises an indicator that, based on said prior user request, said first contact is un-callable from said cellular phone for a user-defined time period.

In some embodiments, the cellular phone may include: a processor able to execute code; and an interface to receive a user command to call the first phone number. In response to said user command, the processor is (a) to block an attempted phone call to the first phone number within said user-defined time period, and (b) to generate a notification to the user that the attempted phone call to the first phone number is blocked until the user-defined time period elapses.

In some embodiments, the contact list may include an indication that, based on a prior user request, said first contact is un-callable from said cellular phone.

In some embodiments, wherein the memory unit comprises a memory unit located within the cellular phone, and not located externally to the cellular phone.

In some embodiments, the memory unit comprises one or more of: a Random Access Memory (RAM) unit, a Flash memory unit, a Secure Digital (SD) card, a SIM card.

In some embodiments, the processor is to block the attempted call based exclusively on data stored within the cellular phone, and not based on data received from a cellular network element external to the cellular phone.

In some embodiments, the processor is to block the attempted call based exclusively on data stored within the cellular phone, and not based on data received from a server computer external to the cellular phone.

In some embodiments, the cellular phone may include: a wireless receiver able to receive wireless communication signals; and a display unit able to display information. The wireless receiver is able to receive a first incoming phone call, which is received from the first phone number, and in response, the processor is to cause the display unit of the cellular phone to display said first phone number to identify said first incoming phone call. The wireless receiver is able to receive a second incoming phone call, which is received from the second phone number, and in response, the processor is to cause the display unit of the cellular phone to display said second phone number to identify said second incoming phone call.

In some embodiments, the cellular phone may include: a display unit able to display information; and an interface to receive from a user a request to add a contact to a contact list stored in said memory unit. In response to said request, the interface is to receive from the user (a) a name of said contact, and (b) a phone number of said contact. In response to said request, the interface is to present to the user an option to mark said contact as un-callable.

In some embodiments, if said contact is marked as un-callable, then the processor is to block an attempt to call said contact.

In some embodiments, the cellular phone or smartphone may include a wireless receiver able to receive wireless communication signals. Regardless of whether or not said contact is marked as un-callable, if the wireless receiver receives an incoming phone call from the phone number of said contact, then the processor is to cause the display unit of the cellular phone to display said phone number to identify said incoming phone call. If said contact is marked as un-callable, then the processor is to block an attempt to call said contact. If said contact is not marked as un-callable, then the processor is to authorize or disallow or prevent an attempted phone call to said contact.

In some embodiments, the cellular phone may include: a display unit able to display information; and an interface to receive from a user a request to add a contact to a contact list stored in said memory unit. In response to said request, the interface is to receive from the user (a) a name of said contact, and (b) a phone number of said contact. In response to said request, the interface is to present to the user an option to mark said contact as un-callable for a user-defined time period.

In some embodiments, if said contact is marked as un-callable, then the processor is to block an attempt to call said contact within said user-defined time period.

In some embodiments, the cellular phone may include a wireless receiver able to receive wireless communication signals. Regardless of whether or not said contact is marked as un-callable, and regardless of said user-defined time period, if the wireless receiver receives an incoming phone call from the phone number of said contact, then the processor is to cause the display unit of the cellular phone to display said phone number to identify said incoming phone call. If said contact is marked as un-callable, then the processor is to block an attempt to call said contact within said user-defined time period. If said contact is not marked as un-callable, then the processor is to authorize an attempted phone call to said contact within said user-defined time period.

In some embodiments, once the user-defined time period expires, the processor is to authorize an attempted phone call to said contact even if said contact was previously marked as un-callable.

In some embodiments, a cellular phone may include: a wireless transmitter able to transmit wireless communication signals; a wireless receiver able to receive wireless communication signals; a memory unit able to store a contact list. The contact list may include: a first contact, comprising a first name associated with a first phone number; and a second contact, comprising: a second name associated with a second phone number. The contact list may include an indication that, based on a prior user request, said first contact is un-callable from said cellular phone, at all, or unless the user performs one or more operations or answers one or more previously-defined questions or security questions.

Some embodiments may include a system, a communication system, a wireless communication system, and/or a cellular communication system, which may include one or more wireless networks. In some embodiments, the system may associate a contact, which may be part of a contact list associated with a user and/or with a phone, with a Call Lock; and the system may block or prevent placement of outgoing calls from that phone towards that contact, or, from that user (on any phone that the same user utilizes, e.g., by utilizing the same user profile or username across different phones). Optionally, the blocking or prevention may be achieved by the system even if the contact list is stored remotely from the phone, in a “cloud” or a “cloud computing” component or server, in remote storage, on a network element, as part of a remotely-stored user profile (e.g., optionally associated with a Web-mail account and/or a Web portal account or a search engine account, such as Google or Yahoo! or Bing), or otherwise externally to the phone.

Some embodiments may include a method of blocking and/or preventing accidental or mistaken placement of a call, from a phone to a contact on a contact list. The method may include, for example: creating a particular contact, or editing a particular contact, in order to indicate that the particular contact is associated with a Call Lock; receiving a user input which indicates that the user commands the phone to place an outgoing phone call towards that particular contact; and, based on the existence of the Call Lock associated with that particular contact, preventing or blocking or disallowing on un-authorizing the placement of the outgoing phone call to that particular contact (or ignoring the user command); optionally, allowing the user to override the Call Lock by answering a confirmation question, or by correctly responding to a challenge/response or to a security question or a password request. In some embodiments, optionally, the method may further include: analyzing call log(s) of the phone and/or of the user, and/or analyzing incoming and/or outgoing communications of the phone and/or the user, and based on the analysis, determining that a particular contact is suitable for placement of a Call Lock; and automatically or semi-automatically creating the Call Lock for that particular contact. Other suitable operations may be used.

In some embodiments, a cellular phone or smartphone may include for example: a memory unit able to store a contact list; a wireless transmitter able to transmit wireless communication signals; a wireless receiver able to receive wireless communication signals; a processor able to execute code; a display unit able to receive; an interface to receive user input. The contact list may include: a first contact comprising a first name associated with a first phone number; a second contact comprising a second name associated with a second phone number. The interface is to receive a user request to make said first contact un-callable from said cellular phone.

In some embodiments, for example, the memory unit is to store (i) a first set of one or more data items representing a first name associated with a first phone number, and (ii) a second set of one or more data items representing a second name associated with a second phone number. In some embodiments, for example, the memory unit is to store a data item indicating that the cellular phone (or other type of phone) is required to block an attempt to call the second phone number (but not the first phone number).

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” or “a plurality” as used herein include, for example, “multiple” or “two or more”. For example, “a plurality of items” includes two or more items.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the machine-readable or computer-readable or device-readable medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor or controller or circuitry which may be coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices or components (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the claims are intended to cover all such modifications, substitutions, changes, and equivalents.

1. A phone comprising:
a wireless transceiver able to place outgoing phone calls and able to receive incoming phone calls;
a processor able to execute code which allows a user to manage a contact list;
a display unit able to present said contact list upon a user request;
a user interface able to receive user input indicating a command to place an outgoing phone call to a particular contact from said contact list;
wherein, in response to said command, if the processor determines that said particular contact is associated with an indication that said particular contact is blocked from being called from said phone, then, the processor is to block an attempt to place the outgoing phone call to said particular contact,
wherein the processor is to determine that a certain contact, which is part of said contact list, is suitable for adding to said certain contact an indication that an outgoing user-initiated phone call to said certain contact is to be blocked, based on an analysis of a content of a text message previously-exchanged between said phone and said certain contact.

2. (canceled)

3. (canceled)

4. (canceled)

5. The phone of claim 1, wherein the user interface is to receive user input indicating which one or more operations, when performed by the user, override blocking of placement of the outgoing phone call to said particular contact.

6. The phone of claim 5, wherein the one or more operations comprise one or more operations selected from the group consisting of:
correctly responding to a user-defined question;
correctly responding to a pseudo-random math question;
correctly entering a user-defined Personal Identification Number (PIN);
correctly entering a user-defined password;
performing one or more user-defined gestures with one or more fingers of the user on a touch-screen of the phone;
selecting a positive answer in response to a confirmation question which is presented to the user and which asks the user to confirm an override of blocking of placement of the outgoing phone call to said particular contact.

7. The phone of claim 1, wherein the user interface is to receive user input indicating an expiration time-point at which said indication, that the particular contact is blocked from being called from said phone, automatically expires;
wherein the time-point comprises a user-defined data item selected from the group consisting of: a calendar date; a weekday; a time-stamp; an indication of a time period to be counted down until expiration.

8. The phone of claim 1, wherein, while said particular contact is marked as blocked from being called from said phone, the processor is to cause the display unit to display a user-defined name of said particular contact upon receiving of a phone call incoming from said particular contact and prior to the user answering said incoming phone call.

9. The phone of claim 1, wherein substantially each contact in said contact list is associated with at least: a field able to store a first name; a field able to store a last name; a phone number; and a field indicating whether or not said phone is to block an outgoing phone call being placed from said phone to said particular contact.

10. The phone of claim 1, wherein the contact list comprises:
a first contact, comprising: a first name associated with a first phone number;
a second contact, comprising: a second name associated with a second phone number;
wherein the contact list comprises an indication that, based on a prior user request, said first contact is non-callable from said cellular phone unless the user of said phone overrides by performing one or more pre-defined steps.

11. The phone of claim 1, wherein, the user interface is to receive user input which switches said particular contact among a set of two or more contact properties that are selected from the list consisting of:
(a) a contact property indicating that the particular contact is callable from said phone;
(b) a contact property indicating that the particular contact is non-callable from said phone;
(c) a contact property indicating that the particular contact is non-callable from said phone unless a previously-placed call lock is removed by the user from said particular contact;
(d) a contact property indicating that the particular contact is non-callable from said phone unless a previously-placed call lock of said particular contact is overridden ad hoc by the user;
(e) a contact property indicating that the particular contact is non-callable from said phone unless the user of the phone actively confirms, via user input, his intent to place the outgoing phone call to said particular contact after being presented with a notification requesting the user to confirm;
(f) a contact property indicating that the particular contact is non-callable from said phone unless the user of the phone overrides the blocking of placement of the outgoing phone call by correctly providing a previously-defined password or PIN;
(g) a contact property indicating that the particular contact is non-callable from said phone unless the user of the phone overrides the blocking of placement of the outgoing phone call by correctly performing one or more previously-defined gestures on a touch-screen of the phone.

12. (canceled)

13. The phone of claim 1, wherein the contact list comprises at least two contacts;
wherein a first contact is associated with a first set of one or more operations required in order to override blocking of outgoing phone calls to said first contact;
wherein a second contact is associated with a second, different, set of one or more operations required in order to override blocking of outgoing phone calls to said second contact.

14. The phone of claim 1, wherein, upon a user command to view the contact list, the processor is to cause the display unit to display at least a portion of the contact list, together with, in proximity to each displayed contact, a visual indication of whether each displayed contact is callable from said phone or is blocked from being called from said phone.

15. The phone of claim 1, wherein the processor is to block the attempt to place the outgoing phone call to said particular contact based exclusively on whether or not said particular contact was previously marked as non-callable by the user of said phone.

16. The phone of claim 1, wherein the processor is to block the attempt to place the outgoing phone call to said particular contact based exclusively on data which is stored locally within said phone.

17. The phone of claim 1, wherein the attempt to place the outgoing phone call to said particular contact is blocked exclusively within said phone, and not externally to said phone by a cellular network element external to said phone.

18. The phone of claim 1, wherein, upon receipt of an incoming phone call from said particular contact, the processor is to cause the display unit to display: (a) a phone number stored in the contact list for said particular contact; (b) a name stored in the contact list for said particular contact; and (c) a visual indication that said particular contact, from which an incoming phone call is being received, was previously defined by the user of the phone as non-callable from said phone.

19. The phone of claim 1, wherein, regardless of whether or not said particular contact is marked by the user of the phone as non-callable from said phone, if the wireless transceiver receives an incoming phone call from the phone number of said particular contact, then the processor is to cause the display unit of the phone to display said phone number to identify said incoming phone call;
wherein, if said particular contact is marked by the user as non-callable, then the processor is to block an attempt to call said particular contact from said phone;
wherein, if said particular contact is not marked as non-callable, then the processor is to authorize an attempt to place a phone call to said particular contact.

20. The phone of claim 1, wherein the user interface is to receive a user request to add or edit a contact item; and in response to said user request, the display unit is to present to the user an option to mark said contact item as non-callable from said phone.

21. The phone of claim 1, wherein, prior to a user selection of said particular contact for purpose of placing an outgoing phone call, the user interface is to receive a user command to override ad hoc any previously-placed call locks; and then, in response to the user selection of said particular contact, even though said particular contact was previously marked as non-callable, the processor is to authorize an ad hoc overriding of blocking of placement of the outgoing phone call to said particular contact.

22. The phone of claim 1, wherein at least one contact on the contact list is associated with a user-defined indication that said contact cannot be sent a text message from said phone; and wherein the processor is to block an attempt to send a text message from said phone to said at least one contact.

23. The phone of claim 1, wherein the processor is to determine that a certain contact, which is part of said contact list, is suitable for adding to said certain contact an indication that an outgoing user-initiated phone call to said certain contact is to be blocked.

24. The phone of claim 1, wherein the processor is to determine, based on an analysis of call logs, that a certain contact which is part of said contact list, is suitable for adding to said certain contact an indication that an outgoing user-initiated phone call to said certain contact is to be blocked.

25. The phone of claim 1, wherein the processor is to receive a user indication that the user pre-approves subsequent suggestions, that the processor suggests, for creating a call prevention lock to contacts; and wherein the processor is to automatically create one or more call prevention locks.

26. The phone of claim 1, wherein the processor is to determine that a particular contact, which is part of said contact list, is suitable for adding to said certain contact an indication that an outgoing user-initiated phone call to said certain contact is to be blocked, based on analysis of speech uttered by a user of said phone during a phone conversation with said particular contact.

27. The phone of claim 1, wherein the processor is to receive an override signal from the user of said phone, prior to the user selecting any particular contact to call, the override signal indicating to override ad hoc any call block which is associated with any contact on the contact list.

28. The phone of claim 1, wherein the processor is to receive an override signal from the user of said phone, prior to the user viewing said contact list, the override signal indicating to override ad hoc a call block which is associated with any contact on the contact list.
